(19) United States
(12) Patent Application Publication
(10) Pub. No.: US 2010/0291868 A1
(43) Pub. Date: Nov. 18, 2010

(54) Controlling Mobile Communication Devices In A Predefined Coverage Area

(76) Inventors: Yossef Meiri, Tel-Aviv (IL); Yaniv Leitner, Modi'in (IL)

Correspondence Address: The Law Office of Michael E. Kondoudis, 888 16th Street, N.W., Suite 800, Washington, DC, 20006, US

(21) Appl. No.: 12/467,761

(22) Filed: May 18, 2009

(51) Int. Cl. H04B 7/00; H04B 5/00

(52) U.S. Cl. 455/41.1; 455/507

(57) ABSTRACT

A system and method for controlling mobile communication devices in a predefined coverage area is provided. One data processing system comprises a cell transceiver connected via a near field communication link to the mobile communication devices in the predefined coverage area and an application in each mobile communication device arranged to control functions of the mobile communication device responsive to the cell transceiver. The cell transceiver is arranged to communicate with the mobile communication devices in the predefined coverage area and thereby control the functions of the mobile communication devices in the predefined coverage area. The system establishes an automated control of the mobile communication devices using a bi-directional communication with the cell transceiver.

### BACKGROUND

1. Technical Field

The present invention relates to the field of mobile communication, and more particularly, to controlling features of mobile communication devices.

2. Discussion of Related Art

Mobiles are getting ever more common, and exhibit evermore functions. However, under certain circumstances, some of these features may be disturbing, and must be shut off. Individual configuration of mobiles in such circumstances is often inefficient and wanting.

### BRIEF SUMMARY

Embodiments of the present invention provide a data processing system for controlling a plurality of mobile communication devices in a predefined coverage area. One data processing system comprises a cell transceiver connected via a near field communication link to the mobile communication devices in the predefined coverage area, and an application in each mobile communication device arranged to control at least one function of the mobile communication device responsive to the cell transceiver. The cell transceiver is arranged to communicate with the mobile communication devices in the predefined coverage area and thereby control the at least one function of the mobile communication devices in the predefined coverage area.

Accordingly, according to an aspect of the present invention, there is provided a system for establishing an automated control of the mobile communication devices using a bi-directional communication with the cell transceiver.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a communication system for controlling mobile communication devices in a predefined coverage area, according to some embodiments of the invention;

FIG. 2 is high level schematic flowchart of a computer implemented method of controlling a plurality of mobile communication devices in a predefined coverage area, according to some embodiments of the invention; and

FIG. 3 is a high level schematic flowchart of a computer implemented method of establishing communication to cell transceiver by mobile communication devices, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner: The term “near field communication link” as used herein in this application, is defined as any close range communication method or medium, such as Bluetooth, WiFi, infrared, Zigbee, WiMax, etc. The term “mode” as used herein in this application, is defined as a collection of all the capabilities of a communication device and their respective states. As examples, a mode may comprise a single function, or multiple functions with each defined as enabled or disabled. Modes may comprise status tables relating to any of the functionalities: volume of various features, connectivity, messages, ringtones, abilities to perform various actions (turning on and shutting off, send and receiving messages, browsing, calling and receiving calls), taking photos, usage characteristics, and so forth.

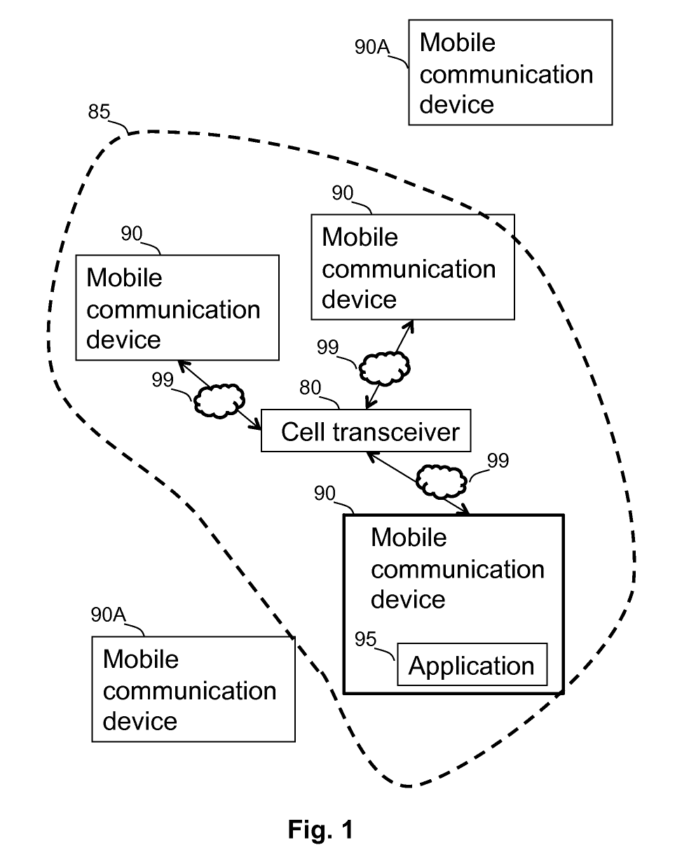

FIG. 1 is a high level schematic block diagram of a data processing system for controlling mobile communication devices 90 in a predefined coverage area 85, according to some embodiments of the invention. Each mobile communication device 90 comprises an application 95 arranged to control at least one function of mobile communication device 90 responsive to cell transceiver 80.

According to some embodiments of the invention, application 95 may be arranged to communicate with cell transceiver 80 in predefined coverage area 85 and allow cell transceiver 80 to control at least one function of at least one mobile communication device 90 in predefined coverage area 85. Application 95 initiates communication to cell transceiver 80, thereby allowing the system to effectively deal with multiple predefined coverage areas 85, multiple mobile communication devices 90 and enable an effective reduction of radiation in a large area covering predefined coverage areas 85.

For example, cell transceiver 80 may mute mobile communication devices 90, send messages to mobile communication devices 90 or determine various parameters for all mobile communication devices 90 in predefined coverage area 85. Cell transceiver 80 may be arranged to control only mobile communication devices 90 within predefined coverage area 85 and not affect mobile communication devices 90A outside predefined coverage area 85. The communication system comprises an automated control of mobile communication devices 90 using a bi-directional communication with cell transceiver 80. Cell transceiver 80 may control all or some of mobile communication devices 90 in predefined coverage area 85, and may affect all or some of their functionalities, as defined in various modes, depending on, e.g., a characterization of mobile communication devices 90. For example, all mobile communication devices 90 may be disabled in respect to ringtone except mobile communication devices 90 defined as emergency devices.

According to some embodiments of the invention, cell transceiver 80 is arranged to communicate mobile communication devices 90 entering predefined coverage area 85 and configure them to be controlled by cell transceiver 80. For example, application 95 may be pre-installed in mobile communication devices 90. Alternatively, application 95 may be installed in mobile communication devices 90 upon entering predefined coverage area 85 and configured to control the functionality of mobile communication devices 90. Application 95 may be self removable. Application 95 may be arranged to look for a nearby cell transceiver 80 and in case one is found—establish a connection between cell transceiver 80 and mobile communication device 90, exchanging predefined modes, rules and information, and so forth. Application 95 may be arranged to repeatedly look for cell transceivers 80, e.g., try to connect every predefined period, to overcome cases of low connectivity, high demands on near field communication link 99, or margins of predefined coverage area 85.

According to some embodiments of the invention, predefined coverage area 85 may be variously defined as a room, an area, a conference area, a theater, exhibition grounds, a class, a vehicle such as a bus, a train, an airplane and so forth.

According to some embodiments of the invention, cell transceiver 80 may be arranged to send mobile communication devices 90 various messages, content and advertisements, for example, a transcription during a performance, useful information (e.g. directions when mobile communication device 90 enters predefined coverage area), coupons and so forth.

According to some embodiments of the invention, cell transceiver 80 may communicate via near field communication link 99 with mobile communication devices 90 within predefined coverage area 85, and not communicate with mobile communication devices 90A outside predefined coverage area 85.

According to some embodiments of the invention, cell transceiver 80 may implement verification procedures to ensure only connection exhibiting predefined characteristics.

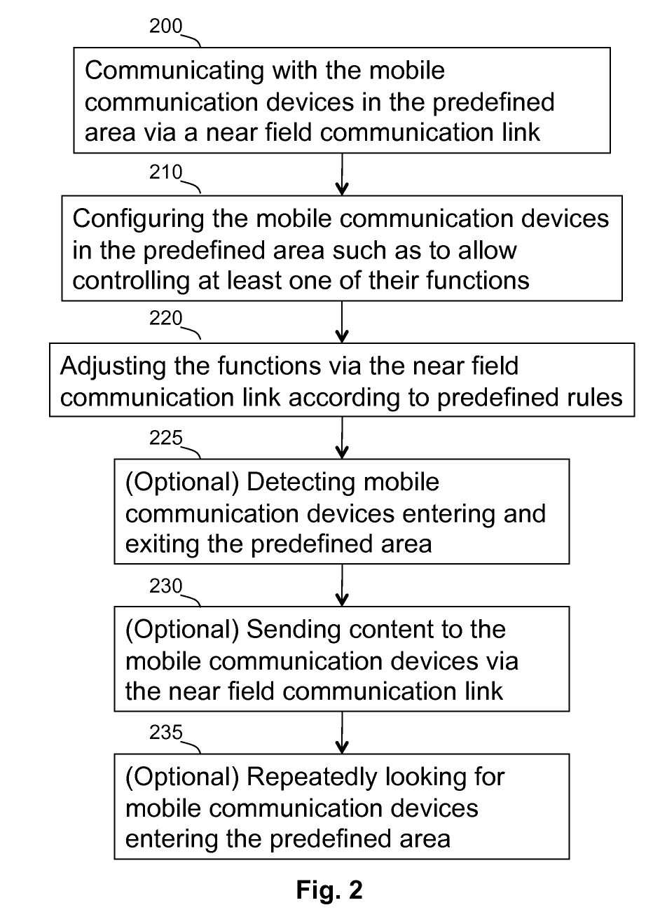

FIG. 2 is a high level schematic flowchart of a computer implemented method of controlling a plurality of mobile communication devices in a predefined coverage area, according to some embodiments of the invention. The computer implemented method comprises the following stages: communicating with the mobile communication devices in the predefined coverage area via a near field communication link (stage 200); configuring the mobile communication devices in the predefined coverage area such as to allow controlling at least one function of the mobile communication devices (stage 210); and adjusting the at least one function via the near field communication link according to predefined rules (stage 220). Such functions may comprise volume of various features, connectivity, messages, ringtones, abilities to perform various actions (sending and receiving messages, browsing, calling, and receiving calls), taking photos, usage characteristics, and so forth. These functions may be arranged in modes as combinations of enabled and disabled functions of the mobile communication device.

According to some embodiments of the invention, the computer implemented method may further comprise detecting mobile communication devices entering and exiting the predefined coverage area (stage 225).

According to some embodiments of the invention, the computer implemented method may further comprise sending content to the mobile communication devices via the near field communication link (stage 230).

According to some embodiments of the invention, the computer implemented method may further comprise repeatedly looking for mobile communication devices entering the predefined coverage area (stage 235).

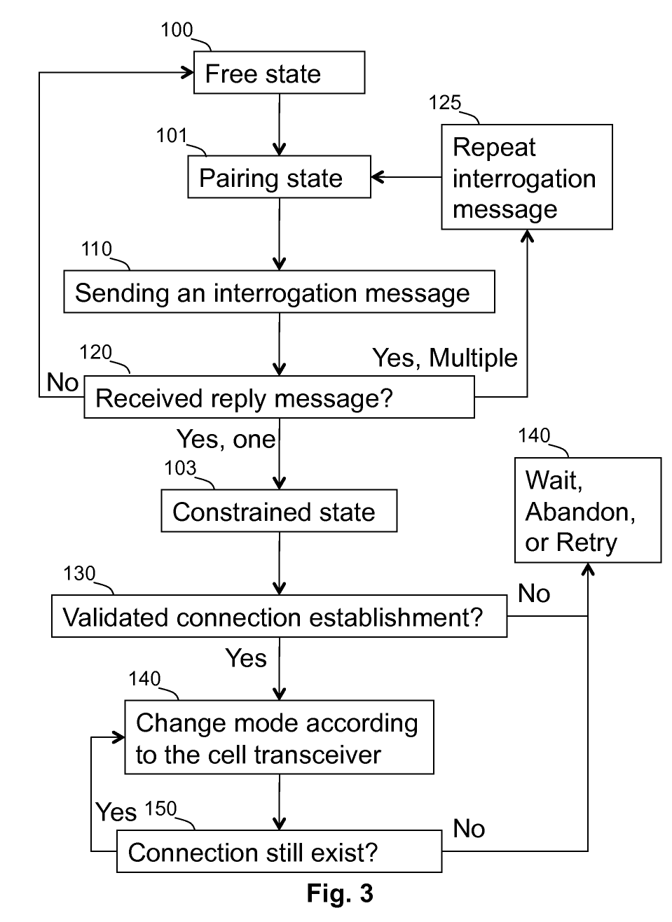

FIG. 3 is a high level schematic flowchart of a computer implemented method of establishing communication to cell transceiver 80 by mobile communication devices 90, according to some embodiments of the invention. Referring to FIGS. 1 and 3, mobile communication device 90 may be in various states: a free state 100 which is the state of mobile communication device 90 prior to communicating with cell transceiver 80 as well as outside any predefined coverage area 85 of any cell transceiver 80. At predefined periods, mobile communication device 90 goes over to a pairing state 101, in which mobile communication device 90 attempts at connecting to cell transceiver 80 by sending an interrogation message 110 (comprising e.g., an identification of mobile communication device 90, setting data of mobile communication device 90 such as possible functions and predefined modes, communication data and security data). Upon receiving the interrogation message from within predefined coverage area 85, cell transceiver 80 may send mobile communication device 90 a reply message via near field communication link 99. Upon receiving the reply message 120, mobile communication device 90 may switch to a constrained state 103 in which mobile communication device 90 first validates the establishment of a connection 130 to cell transceiver 80. If multiple reply messages are received 120, mobile communication device 90 may stay in pairing state 101 and repeat sending interrogation message 125. This may happen when mobile communication device 90 is on the border between two coverage areas 85, in which case it retries connecting until the conflict resolves due to traffic at cell transceiver 80 or motion of mobile communication device 90. When establishment of a connection is not validated 140, mobile communication device 90 may continue acknowledging cell transceiver 80 for a predefined period until a connection is established, or abandon the connection and return to a free state 100. Alternatively, upon pending connection establishment, mobile communication device 90 may move to a pending exit state, which may occur on the edge of one or more coverage areas 85, in which mobile communication device 90 attempts reconnection to former cell transceiver 80. Alternatively, mobile communication device 90 may switch to pairing state 101 and try connecting to a new cell transceiver 80. Within predefined coverage area 85 the mode of mobile communication device 90 is dictated by corresponding cell transceiver 80, i.e., mobile communication device 90 changes modes 140 according to the cell transceiver 90. Mobile communication device 90 may check occasionally the validity and existence of a connection 150 to cell transceiver 80, e.g., upon restarting or turning on of mobile communication device 90.

According to some embodiments of the invention, the computer implemented method may further comprise mobile communication devices 90 attempting to connect cell transceiver 80 controlling predefined coverage area 85 via near field communication link 99, and upon successful connection, mobile communication devices 90 allowing cell transceiver 80 to control the at least one function via near field communication link 99.

According to some embodiments of the invention, modes may be defined at cell transceiver 80, and interpreted in different ways at various mobile communication devices 90. Coding of modes may vary among mobile communication devices 90.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for controlling a plurality of mobile communication devices in a predefined coverage area, comprising:
a cell transceiver connected, via a near field communication link, to the mobile communication devices in the predefined coverage area, and
an application in each mobile communication device that controls at least one function of each respective mobile communication device in response to the cell transceiver,
the application controlling each mobile communication device to communicate with the cell transceiver in the predefined coverage area and allowing the cell transceiver to control the at least one function of the mobile communication devices in the predefined coverage area.

2. The data processing system of claim 1, wherein the at least one function is a combination of enabled and disabled functions of the at least one of the mobile communication device.

3. The data processing system of claim 1, wherein the cell transceiver may be further arranged to install the application onto the mobile communication devices upon their entering the predefined coverage area.

4. The data processing system of claim 1, wherein the cell transceiver may be disabled from communicating with mobile communication devices outside the predefined coverage area.

5. The data processing system of claim 1, wherein the application causes each mobile communication device to repeatedly look for cell transceivers.

6. A method of controlling a plurality of mobile communication devices in a predefined coverage area, comprising:
communicating with the plurality of mobile communication devices in the predefined coverage area, via a near field communication link;
configuring the plurality of mobile communication devices in the predefined coverage area so as to allow controlling at least one function of the respective mobile communication devices; and
adjusting the at least one function via the near field communication link according to predefined rules.

7. The method of claim 6, wherein the at least one function is a combination of enabled and disabled functions of mobile communication device.

8. The method of claim 6, further comprising detecting mobile communication devices entering and exiting the predefined coverage area.

9. The method of claim 6, further comprising sending content to the mobile communication devices via the near field communication link.

10. The method of claim 6, further comprising repeatedly looking for mobile communication devices entering the predefined coverage area.

11. The method of claim 6, further comprising: attempting, via the mobile communication devices, to connect to a cell transceiver controlling a predefined coverage area via the near field communication link; and allowing the cell transceiver to control the at least one function via the near field communication link, when the mobile communication devices connect to the cell transceiver.
